(19) United States
(12) Patent Application Publication
(10) Pub. No.: US 2017/0350774 A1
(43) Pub. Date: Dec. 7, 2017

(54) DIRECT LIGHT BEND SENSOR

(71) Applicant: Mark B. Woodbury, North Salt Lake, UT (US)

(72) Inventor: Mark B. Woodbury, North Salt Lake, UT (US)

(21) Appl. No.: 15/612,993

(22) Filed: Jun. 2, 2017

Related U.S. Application Data
(60) Provisional application No. 62/344,704, filed on Jun. 2, 2016.

(51) Int. Cl. G01L 1/24

(52) U.S. Cl. CPC G01L 1/243

(57) ABSTRACT

A direct light bend sensor is disclosed. A system that includes direct light bend sensor and method for measuring the force using a direct light bend sensor are also disclosed. In some embodiments, the direct light and sensor includes a tube that is elastically flexible, made of a darkening material, and has a light absorbing inner surface. In the embodiment, a light source is disposed in a first end portion of the tube and a photodetector is disposed in a second end portion of the tube. In the embodiment, an inner surface of the tube defines a bend-dependent direct light path from the light source to the photodetector through the tube.

### FIELD

Embodiments of the invention relate generally to flexible bend sensors and more particularly to direct light bend sensors, including fluid-filled direct light bend sensors.

### BACKGROUND

Flexible bend sensors are used to measure the degree of bending of the sensor. Flexible bend sensors are used in a variety of mechanical, industrial, medical applications. Bend sensors may be embedded within an object or attached to objects in order to measure movement of the object or movement of the object relative to another object. For example, bend sensors may be used in automotive applications to measure the flexure of a surface connected to the steering wheel by which a horn is sounded when the surface is flexed sufficiently. A bend sensor may be embedded within a car seat so that when an occupant is seated in the seat the bend sensor flexes and signals that the seat is occupied. Bend sensors may employ electro-optical technologies including fiber optics, as well as electromechanical technologies such as flexible substrates with resistance that varies according to the degree of bending.

### SUMMARY

An apparatus for a flexible direct light bend sensor is disclosed. A system and method also perform the functions of the apparatus. In some embodiments, a direct light bend sensor is disclosed that includes a tube that is elastically flexible, made of a darkening material, and has a light absorbing inner surface. In the embodiment, a light source is disposed in a first end portion of the tube and a photodetector is disposed in a second end portion of the tube. In the embodiment, an inner surface of the tube defines a bend-dependent direct light path from the light source to the photodetector through the tube.

In some embodiments, a method for measuring force is disclosed that includes coupling a direct light bend sensor to a first object. In the embodiment, the direct light bend sensor includes a tube that is elastically flexible, made of a darkening material, and has a light absorbing inner surface. The direct light bend sensor of the embodiment further includes a light source disposed in a first end portion of the tube and a photodetector disposed in a second end portion of the tube, where an inner portion of the tube defines a bend-dependent direct light path from the light source to the photodetector. The method further includes positioning the direct light bend sensor to be at least partially bent in response to a first force being applied to at least a portion of the tube and measuring a signal from the photodetector that indicates a magnitude of the first force.

In some embodiments, a system is disclosed that includes a direct light bend sensor that is coupled to a first object. In the embodiments, the direct light bend sensor includes a fluid-filled tube that is elastically flexible, made of a darkening material, and has a light absorbing inner surface. The direct light bend sensor further includes a light source disposed in a first end portion of the fluid-filled tube and a photodetector disposed in a second end portion of the fluid-filled tube. In the embodiments, an inner surface of the tube defines a bend-dependent direct light path from the light source to the photodetector through the fluid-filled tube. In the embodiments, the system also includes a controller that measures changes in a signal from the photodetector in response to a bending of a least a portion of the fluid-filled tube, the bending in response to a force being applied to a second object.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict merely typical embodiments of the invention and are not therefore to be considered to be limiting of its scope, the invention will be described and explained with additional specificity and detail through the use of the accompanying drawings, in which:

FIG. 1A is a schematic block diagram illustrating one embodiment of a resistive bend sensor depicted in a straightened disposition;

FIG. 1B is a schematic block diagram illustrating the resistive bend sensor of FIG. 1A depicted in a bent disposition;

FIG. 2A is a schematic block diagram illustrating one embodiment of a light guide bend sensor having optical fibers and depicted in a straightened disposition;

FIG. 2B is a schematic block diagram illustrating the light guide bend sensor of FIG. 2A depicted in a bent disposition;

FIG. 2C is a schematic block diagram illustrating an end view of the light guide bend sensor of FIG. 2A depicted in a straightened disposition;

FIG. 3A is a schematic block diagram illustrating one embodiment of a fluid-filled light guide bend sensor having a reflective inner surface and depicted in a straightened disposition;

FIG. 3B is a schematic block diagram illustrating the fluid-filled light guide bend sensor of FIG. 3A depicted in a bent disposition;

FIG. 3C is a schematic block diagram illustrating an end view of the fluid-filled light guide bend sensor of FIG. 3A depicted in a straightened disposition;

FIG. 4A is a schematic block diagram illustrating one embodiment of a fluid-filled direct light bend sensor having a light absorbing inner surface and depicted in a straightened disposition with a direct light path unblocked;

FIG. 4B is a schematic block diagram illustrating an end view of the fluid-filled direct light bend sensor of FIG. 4A in a straightened disposition with the direct light path unblocked;

FIG. 4C is a schematic block diagram illustrating a side view of the fluid-filled direct light bend sensor of FIG. 4A in a bent disposition with a direct light path partially blocked;

FIG. 4D is a schematic block diagram illustrating an end view of the fluid-filled direct light bend sensor of FIG. 4A in a bent disposition with the direct light path partially blocked;

FIG. 4E is a schematic block diagram illustrating a side view of the fluid-filled direct light bend sensor of FIG. 4A in a further bent disposition with the direct light path blocked;

FIG. 4F is a schematic block diagram illustrating an end view of the fluid-filled direct light bend sensor of FIG. 4A in a further bent disposition with the direct light path blocked;

FIG. 5 is a schematic block diagram illustrating one embodiment of system that includes a direct light bend sensor connected to a controller and an output module;

FIG. 6 is a graph of an output signal from a fluid-filled direct light bend sensor;

FIG. 7A is a schematic block diagram illustrating one embodiment of a fluid-filled direct light bend sensor with a flared end portion;

FIG. 7B is a schematic block diagram illustrating the fluid-filled direct light bend sensor of FIG. 7A coupled to a first object using a cable clamp and configured to measure force applied by a second object;

FIG. 8 is a schematic block diagram illustrating one embodiment of a system that includes a fluid-filled direct light bend sensor configured to directly measure flow;

FIG. 9A is a schematic block diagram illustrating one embodiment of a system that includes a fluid-filled direct light bend sensor configured to measure flow using an articulating arm;

FIG. 9B is a schematic block diagram illustrating a top view of the system of FIG. 9A;

FIG. 9C is a schematic block diagram illustrating a top view of the fluid-filled direct light bend sensor of the system of FIG. 9A configured with a calibration screw;

FIG. 10 is a schematic block diagram illustrating an embodiment of a system that includes fluid-filled direct light bend sensor configured to measure pressure applied to a plunger;

FIG. 11 is a schematic block diagram illustrating another embodiment of a system that includes fluid-filled direct light bend sensor configured to measure pressure applied to a membrane;

FIG. 12 is a schematic flow chart diagram illustrating one embodiment of a method for measuring a force using a fluid-filled direct light bend sensor.

FIG. 13 is a schematic flow chart diagram illustrating another embodiment of a method for measuring a force using a fluid-filled direct light bend sensor.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “substantially” as used herein is intended to mean predominantly or having the overriding characteristic of, such that any opposing or detracting characteristics reach a level of operational insignificance to use of the apparatuses, systems, or methods disclosed herein. Any element in a claim that does not explicitly state “means for” performing a specified function, or “step for” performing a specific function, is not to be interpreted as a “means” or “step” clause as specified in 35 U.S.C. §112, ¶6. In particular, the use of “step” or “step of” in the claims herein is not intended to invoke the provisions of 35 U.S.C. §112, ¶6. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

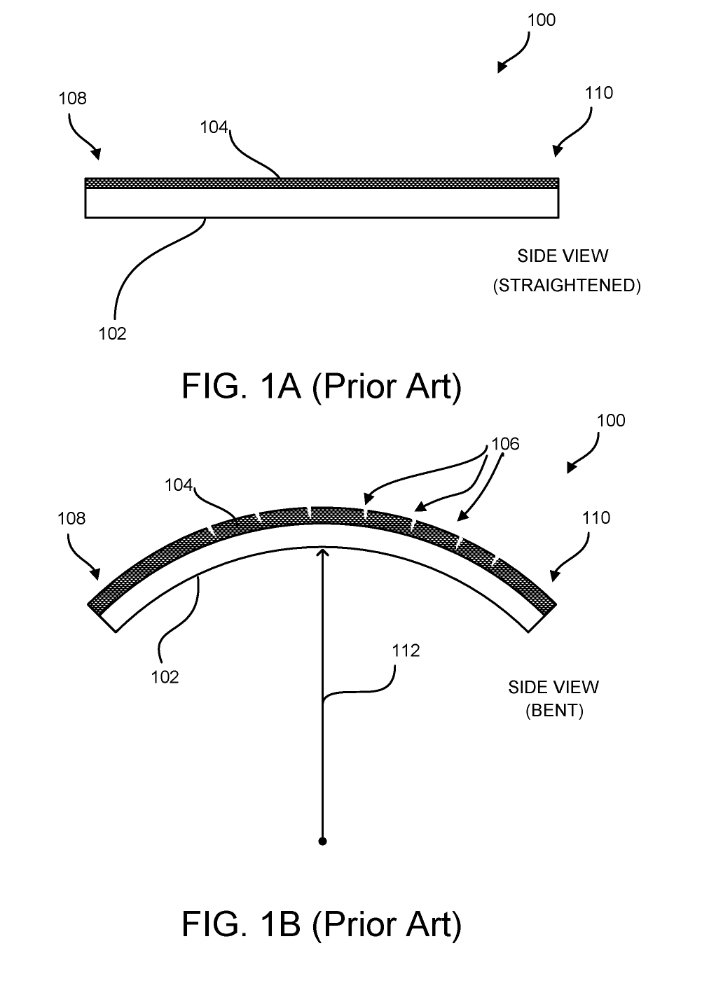

FIG. 1A is a schematic block diagram illustrating one embodiment of a resistive bend sensor 100 depicted in a straightened disposition. The resistive bend sensor 100 includes a flexible substrate 102 and a resistive layer 104 that is flexible. The resistive bend sensor has a first end portion 108 and a second end portion 110. The flexible substrate 102 may be a flexible strip of a polymer film, such as for example, polyimide film Kapton®. The resistive layer 104 may be a thin flexible layer of resistive carbon coupled to or layered upon the flexible substrate 102. The resistance of the resistive layer 104 changes as the carbon layer is elongated or compressed by the bending of the flexible substrate 102. A first measurement of the resistance of the resistive layer 104 between the first end portion 108 and the second end portion 110 may be made as a reference for the resistive bend sensor 100 in a straightened disposition.

FIG. 1B is a schematic block diagram illustrating the resistive bend sensor 100 of FIG. 1A depicted in a bent disposition. A second measurement of the resistance of the resistive layer 104 between a first end portion 108 and second end portion 110 may be made as a reference for the sensor in a substantially bent position. The radius of curvature 112 is the reciprocal of the curvature of the arc formed by the sensor. By comparing the resistance of the flexible resistive sensor in a first straightened disposition as illustrated in FIG. 1A and a bent disposition as illustrated in FIG. 1B the range of resistance may be calibrated so that a measurement of a bend curvature may be made at any degree of curvature.

Breaks or cracks in the carbon substrate, also referred to as the resistive layer 104, may be intentionally designed into a resistive bend sensor such that the resistance changes with bending. When this type of sensor is constructed, the resistive layer 104 may be stressed with the intention that no further cracks develop during its intended use. Yet, sometimes unintended cracks 106 may begin to form in the resistive layer 104. The unintended cracks 106 may alter the resistive properties of resistive layer 104, for example, by creating an unanticipated increase in resistance during bending This may result in an open circuit that has effectively nearly infinite resistance, which may make the measurements vary over time, thus decreasing the accuracy of the measurements and/or requiring more frequent calibration of the resistive bend sensor 100.

Bending the resistive bend sensor 100 may, in some cases, result in a nearly immediate increase in resistance, but when straightening the resistive bend sensor 100 out, it may take a longer time for the resistance to decrease again. This hysteresis effect may limit the usefulness of the resistive bend sensor 100 to applications requiring dynamic responsiveness. Moreover, the resistance of the resistive bend sensor 100 may drift over time which, for purposes of this application, would also be considered a type of hysteresis.

The resistive bend sensor 100 be may a generally planar strip. For example, it may be ribbon-shaped or belt-shaped and thus, may be typically used in applications where a bending force is applied orthogonally to the plane of the sensor as depicted in FIG. 1B. Bending of a planar strip sideways to the plane of the strip may be difficult and thus planar, belt-like bend sensors maybe less suitable for measuring a degree bending in certain dimensions that are not orthogonal to the plane of the strip.

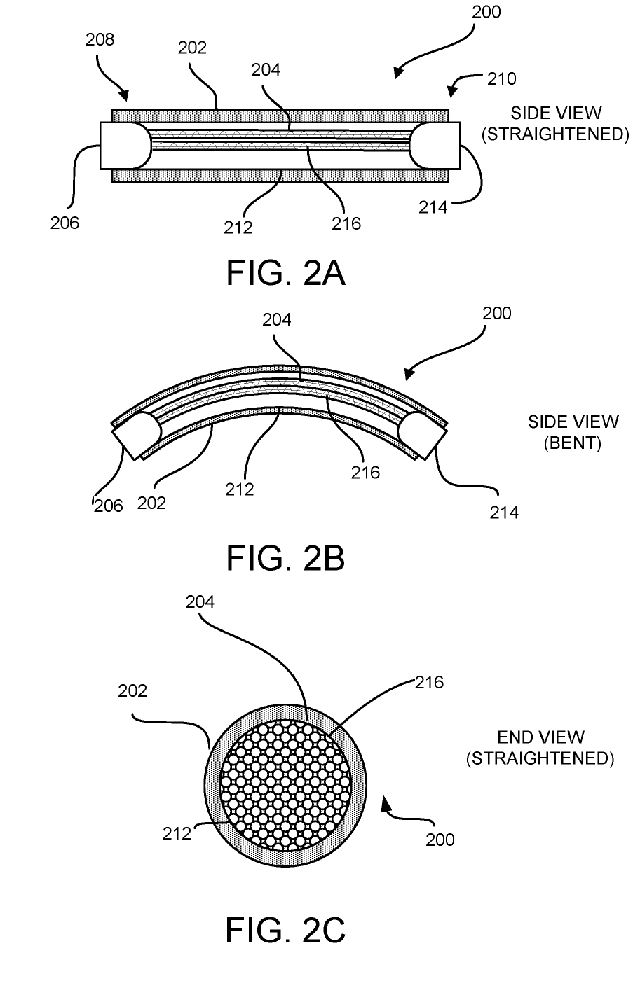

FIG. 2A is a schematic block diagram illustrating one embodiment of a light guide bend sensor 200 having optical fibers and depicted in a straightened disposition. In some embodiments, the light guide bend sensor 200 includes a tube 202 that is at least partially filled with a transfer medium 204 that is a flexible solid, such as for example, optical fibers, or another flexible solid light transmissive material that extends within the tube 202, from a light source 206 disposed at a first end portion 208 of the tube 202 to a photodetector 214 disposed at a second end portion 210 of the tube 202.

As used herein, the word tube refers to a conduit that may be hollow and that may, in some embodiments, be filled with an optically transmissive fluid, such as air, inert gas, water, oil. In some embodiments, the tube 202, may be substantially cylindrical, i.e., may have a substantially circular cross-section. However, in other embodiments the tube 202 may have a non-cylindrical shape, such as for example, a shape having a square, rectangular, triangular, or oval, or arbitrarily shaped cross-section.

Moreover, in some embodiments, the exterior of the tube 202 may have a different shape than the interior of the tube 202. For example, in applications where flow is measured, the exterior of the tube 202 may be shaped like an oar to more readily provide a broader surface upon against which the flow may apply a force. Similarly, a portion of the exterior of the tube 202 may be attached or otherwise coupled to one or more objects such that movement of the one or more objects applies a force to the portion of the tube 202.

Unless otherwise clear from the context, reference to elements of a bend sensor, such as for example the tube 202, may be understood to similarly refer to other embodiments of a similar tube shown in one or more of the other figures (e.g., 302, 402, 502, 702, and 802 which are illustrated and described below with respect to FIGS. 2B, 3B, 5A, 5B, 6A, 6B, 7A, 8B, and 9-10C.

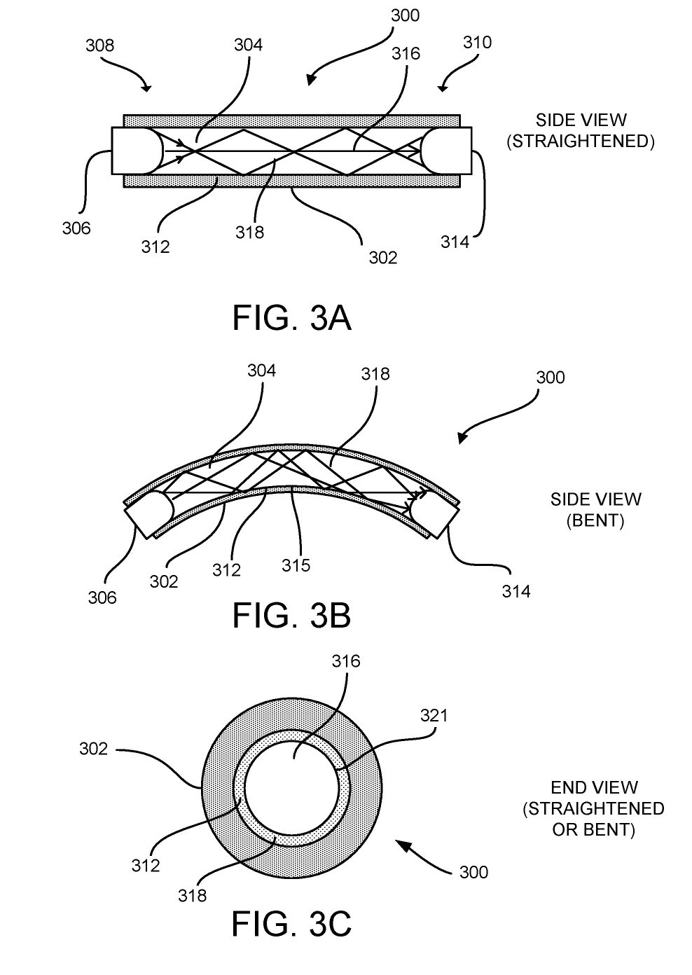

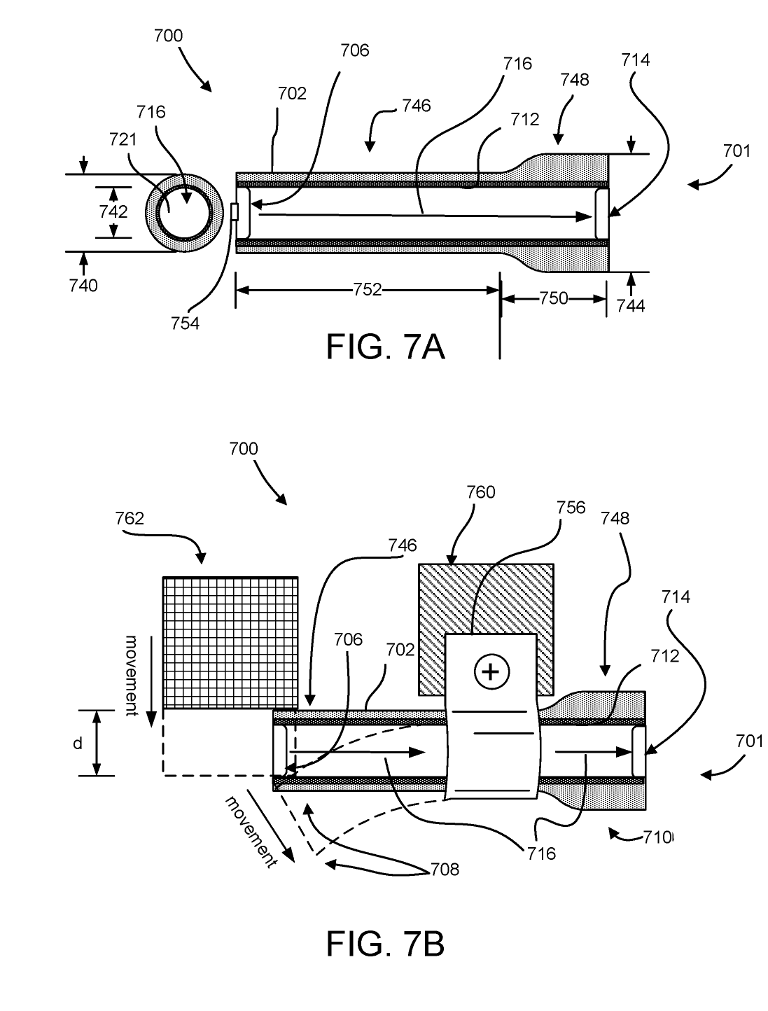

It may be noted by a person of ordinary skill that applying a force to a portion of the tube 202 may cause at least a portion of the tube 202 to bend. In some embodiments, the tube 202 (or similar tubes in other embodiments) may be bent symmetrically, such as for example, as depicted in FIGS. 3B, 4C-4F, and 5. In other embodiments, the tube 202 may be bent asymmetrically, such as for example, bent by a portion of the tube being pushed by an object as depicted in FIGS. 7B, 8, 9A-9C, 10A-10C, and 11. In other words, in some embodiments, only a portion of the tube 202 (or similar tubes depicted in the embodiments illustrated in other figures) is bent by application of a force to the tube 202.

A guided light 216 is illustrated as representative of light shining through the transfer medium 204 (e.g., optical fibers) from the light source 206 to the photodetector 214. Because bend sensors are configured to bend, the tube 202 is flexible and may be made be made of polymers, elastomers, and the like. The tubes illustrated in the other figures e.g., 302, 402, 502, 702, and 802 may be similarly flexible.

In some embodiments in which tube 202 is in a straightened disposition, the guided light 216 may be transmitted through the transfer medium 204 with some refraction and some internal reflection. Transfer media with higher indices of refraction may cause substantial refraction, sometimes visualized as apparent bending of guided light 216. Transfer media with low indices of refraction such as air or a vacuum or various other light gases may cause substantially less refraction of the guided light 216 as it travels from the light source 206 to the photodetector 214, such that if an inner surface 212 of the tube 202 is reflective, the bending of the inner surface 212 acts as a light guide by reflecting the guided light 216 towards the photodetector 214.

Although some embodiments depict an inner surface of a tube such as the inner surface 212 of the tube 202, it may be noted that references to an inner surface of a tube in the various embodiments may refer to either a surface which is composed of the same material as the rest the tube, such as for example latex rubber, or in other embodiments may refer to a surface which is composed of different material from the rest of the tube such as for example a surface coating that is applied to an interior portion of the tube.

FIG. 2B is a schematic block diagram illustrating the light guide bend sensor 200 of FIG. 2A depicted in a bent disposition. The transfer medium 204 may include optical fibers or other optically transmissive media with an index of refraction sufficient to cause substantial refraction or reflection of the guided light 216 as it travels from the light source 206 to the photodetector 214. Much of the guided light 216 is refracted and internally reflected within the transfer medium 204 (e.g. fiber optics or other refractive flexible solid transfer medium) such that the inner surface 212 may be reflective or may alternatively be light absorbing without substantial impact on the amount of light transmitted through the transfer medium 204. Some degree of light may escape from the transfer medium 204 and be reflected by the inner surface 212 if the inner surface 212 is reflective. Thus, in some embodiments, in which the transfer medium 204 includes for example fiber optics, using a tube that has an inner surface 212 that is light absorbing may be preferable in order to reduce any reflection of the guided light 216 back into the transfer medium 204, e.g. the optical fibers.

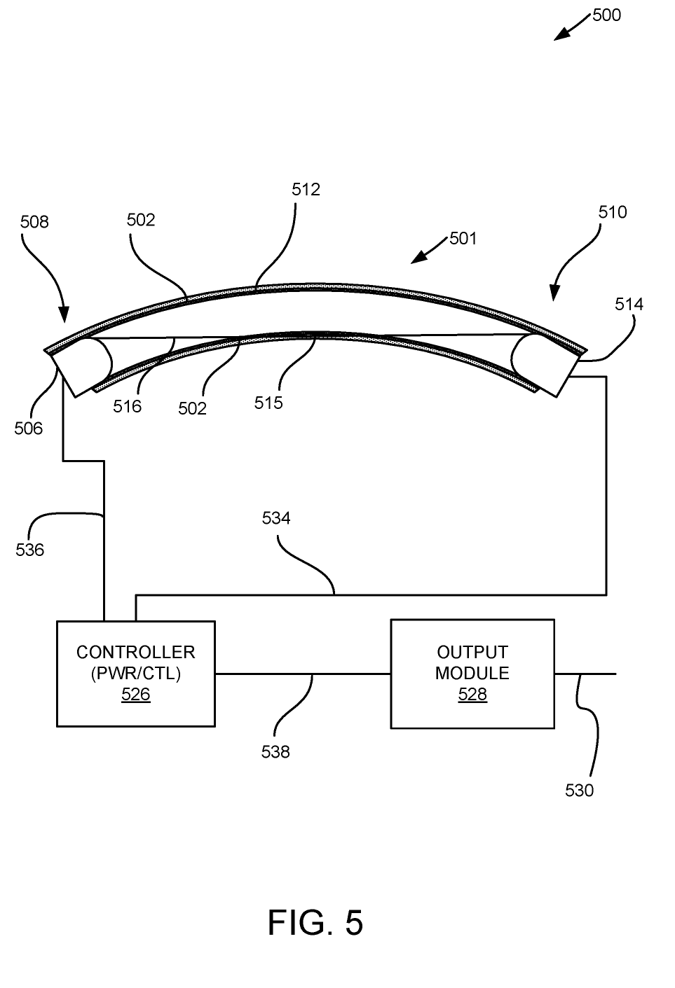

The transfer medium 204, such as for example, the optical fibers may be obtained in very long lengths and with very small bend radii. The bend radius means the minimum radius of curvature at which the optical fibers or the tube may be bent while retaining its intended form, and below which the optical fibers or the tube (e.g., tube 202) may become deformed (e.g., kinked or broken). Thus, optical fibers may be quite useful for long bend sensors, or bend sensors used in circumstances where tight bends need to be measured. Optical fibers may add cost to the light guide bend sensor 200. Use of optical fibers may also lead to an increase in the cost of the photodetector 214 and an associated controller in order to detect with changes in light intensity with sufficient sensitivity. In FIG. 5, a controller 526 is depicted and described in the corresponding description. A similar type of controller 526 may be used and/or adapted to electrically connect to and control the various embodiments of the bend sensors depicted in any of the Figures.

FIG. 2C is a schematic block diagram illustrating an end view of the light guide bend sensor of FIG. 2A depicted in a straightened disposition. The tube 202 surrounds the transfer medium 204, e.g., optical fibers, and the guided light 216 is transmitted through the tube 202. If the inner surface 212 of the tube 202 is reflective, some of guided light 216 may escape the optical fibers and may be reflected back into the fiber. The intensity of the guided light 216 may vary according to the degree of bending or the angle of curvature of the bent tube. The photodetector 214 may need to be more sensitive, and/or a detection algorithm associated with the photodetector 214 may need to be somewhat sophisticated in order to detect subtle changes in the guided light 216 as it passes through the bent or straightened transfer medium 204 that includes fiber optics.

In fiber optic type light guide bend sensors, there is typically no aperture or open direct light path between the first end portion 208 and the second end portion 210 of the tube 202 because the inner diameter of tube 202 is filled with optical fiber or another transfer medium 204 that is solid and optically transmissive. As used herein aperture refers to a cross-sectional area of a line of sight direct light path defined by the inner surface of a tube, e.g., tube 202 in any bent, partially bent, or straightened disposition. Since optical fiber is typically inherently refractive and internally reflective, guided light 216 is not considered direct light (e.g. line-of-sight) within the meaning of the term direct light as used within this application.

FIG. 3A is a schematic block diagram illustrating one embodiment of a fluid-filled light guide bend sensor having a reflective inner surface and depicted in a straightened disposition. The tube 302 may be substantially hollow and filled with a fluid, such as for example air, an inert case, water, silicone oil, or any transfer medium 304 that is a fluid, so that a direct light path through the aperture 321 is defined by an inner surface 312 of the tube 302. For purposes of this application, “direct light” means light traveling along a straight line-of-sight path substantially without reflection, for example, from a light source 306 disposed at a first end portion 308 of the tube 302 to a photodetector 314 disposed at a second end portion 310 of the tube 302.

Although direct light may be transmitted from the light source 306 to the photodetector 314, a significant amount of reflected light 318 may also be transmitted to the photodetector 314. Accordingly, the light guide bend sensor 300 may not be regarded as a direct light bend sensor since in addition to the direct light 316 reaching the photodetector 314, a non-negligible amount of the reflected light 318 may reach photodetector 314, especially when the tube 302 is in a bent disposition such as will be discussed with respect to FIGS. 3B-3C.

The light source 306 (and similar light sources e.g., 406, 506, 706, and 806, which are illustrated other Figures and described below) may include any light emitting element or combination of elements such as light emitting diodes, laser diodes, radioluminescent light sources such as tritium tubes, electroluminescent light sources, incandescent bulbs, gas discharge bulbs, and the like. In some embodiments, the light emitting element(s) of the light source 306 emit(s) visible light. In some embodiments, one advantage of visible light is that an assembler or other person working with the light guide bend sensor 300 (or with a direct light bend sensor 400, 501, 701, or 801) can readily perceive whether the light source is on or off if the light emitting element is not completely enclosed within the tube, e.g., tube 302. Moreover, some types of photo detectors are more readily available and visible light wavelengths, such as for example, cadmium sulfide photocells.

In other embodiments, the light emitting element emits infrared light. Photodetectors such as photodiodes and photo transistors have excellent performance to cost ratios and very good sensitivity as well as excellent linearity in the infrared wavelengths as well as in the visible wavelengths. Accordingly, one of ordinary skill may choose light emitting diodes that emit electromagnetic radiation in the range from about 240 nm to about 940 nm. In some embodiments, the light emitting elements may include emitting diodes (LEDs) that are relatively inexpensive and readily available and may emit light in any selected wavelength from deep ultraviolet LEDs with wavelengths centered at about 240 nm to infrared LEDs with wavelength centered at about 940 nm.

The photodetector 314 (and similar photodetectors e.g., 414, 514, 714, and/or 814 which are illustrated other Figures and described below) may include any photo-detecting or light-sensing elements or combination of elements including photoresistors, photodiodes, phototransistors, cadmium sulfide cells, photovoltaic cells, and the like. The wavelength of light detected by the photodetector 314 may generally correspond with, or overlap with, the wavelength of light emitted by the light source 306.

The tube 302 (and similar tubes e.g., 402, 502, 702, and/or 802, which are illustrated other Figures and described below) may be air-filled or may be filled with another transfer medium 304 that is a fluid, such as for example, inert gases, water, silken oil, or other liquids. Air as a transfer medium has a very low index of refraction. An air-filled tube may also be easier and less costly to manufacture than a tube that includes a transfer medium 304 other than air. In some embodiments, the tube 302 may be substantially sealed such that the transfer medium 304 does not go into or out of the tube 302 during use.

In other embodiments, the tube 302 may be unsealed such if the transfer medium 304 is a fluid (liquid or gas), the fluid may go into or out of the tube 302 during use. Whether a tube is sealed or unsealed may also have an effect on the reaction of the tube 302 to a bending force applied to the tube 302. For example, if the tube 302 is a sealed tube filled with a transfer medium 304 that is a liquid fluid, the tube 302 may be more elastically flexible in response to a force being applied to the tube 302 and then released.

In some embodiments, the inner surface 312 of the tube 302 may be reflective as depicted in FIGS. 3A-3C. In embodiments in which the inner surface 312 is reflective, the reflected light 318 may be transmitted from the light source 306 to the photodetector 314, in addition to the direct light 316 being transmitted from the light source 306 to the photodetector 314. The reflectivity of the inner surface 312 may be wavelength dependent.

In other embodiments, the inner surface 312 of the tube 302 (and similar inner surfaces e.g., 412, 512, 712, and/or 812, which are illustrated other Figures and described below) may be light absorbing. As used herein, the term light absorbing means that the inner surface e.g., inner surface 312, absorbs more light than it reflects for a given wavelength of light emitted from a light source, such as for example, light source 306. In some embodiments, the inner surface 312 is made of a light absorbing material such as for example a flat black latex, or flat black rubber. In other embodiments, a material such as polyimide e.g., Kapton®, is light absorbing because it absorbs more light than it reflects for a given wavelength of light emitted from the light source 306.

FIG. 3B is a schematic block diagram illustrating the fluid-filled light guide bend sensor of FIG. 3A depicted in a bent disposition. The direct light path (line of sight) may be blocked by an apex 315 of the arc formed at the bend of inner surface 312. Thus, an aperture 321 may be formed by the inner surface 312 that defines a direct line-of-sight light path, from the light source 306 at first end portion 308 of tube 302 is substantially unblocked by the apex 315 of the inner surface 312. The aperture 321 or the direct line-of-sight path traveled by the direct light 316 is thus referred to as a bend-dependent direct light path. Similarly, the light path for direct light 416, 516, and/or 716 may also be referred to as bend-dependent direct light paths.

Moreover, although the degree of curvature of tube 302 depicted in FIG. 3B is readily apparent for purposes of illustration, a much lower degree of curvature may change the aperture 321 by partially blocking direct light in such a way that even a slight degree of bending is detectable. If the radius of curvature is very large (e.g. an ideally fully straightened tube has an infinite radius of curvature), a small change in curvature may result in a small change the size of the aperture 321 and consequently a small change in light intensity, which, nevertheless may be detectable.

The reflected light 318 may be reflected off various points of the inner surface 312 to reach the photodetector 314. Although the reflected light 318 may have somewhat less intensity than direct light 316, the degree of bending may be detected by measuring the intensity of light received by photodetector 314. In some embodiments, this measuring may be facilitated by sensitive or sophisticated circuits and algorithms for detecting changes in light intensity associated with bending of tube 302, as may be the case for detecting light refracted through transfer media such as optical fiber.

FIG. 3C is a schematic block diagram illustrating an end view of the fluid-filled light guide bend sensor of FIG. 3A depicted in a straightened disposition, from the perspective of the photodetector 314 with a direct light 316 shining through the center of tube 302 with minimal refraction. The direct light 316 may be distinguished from the reflected light 318 or refracted light. In embodiments in which inner surface 312 is reflective, the reflected light 318 may be reflected off of the inner surface 312 so as to also reach photodetector 314.

The aperture 321 refers to the line-of-sight opening from a first end portion of tube 302 to a second end portion of tube 302. The paths of direct light 316, 416, 516, and 716, and the apertures 321, 421, are similarly bend-dependent. In some embodiments, the tube 302 may be in a straightened disposition or alternatively in a substantially bent disposition and the difference in the intensity of light that reaches photodetector 314 in the two dispositions will vary less, due to the reflectivity of inner surface 312, than it would if inner surface 312 had a light absorbing surface.

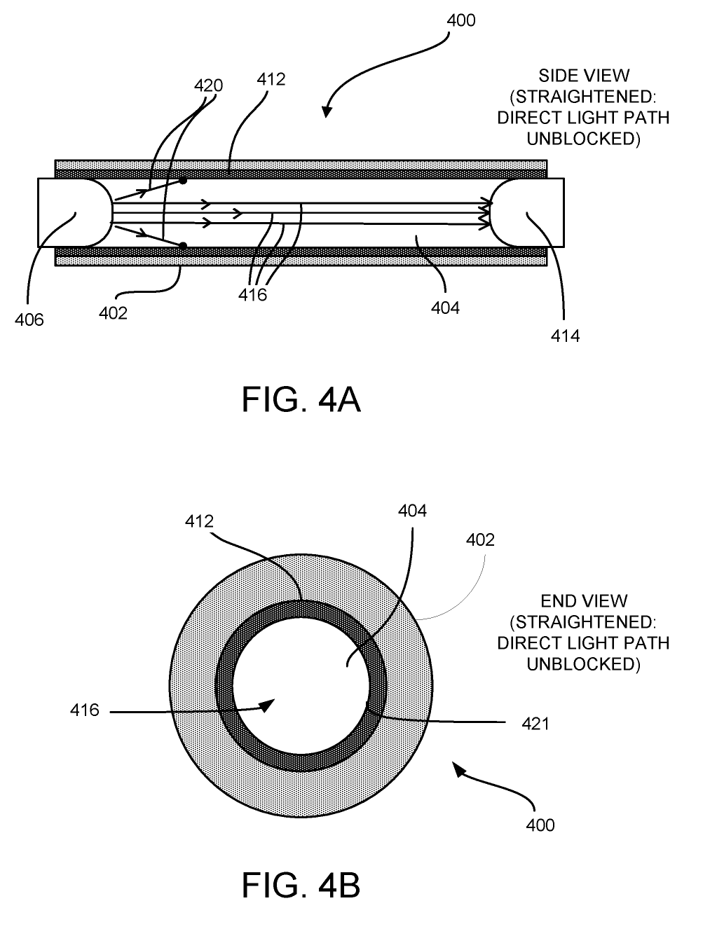

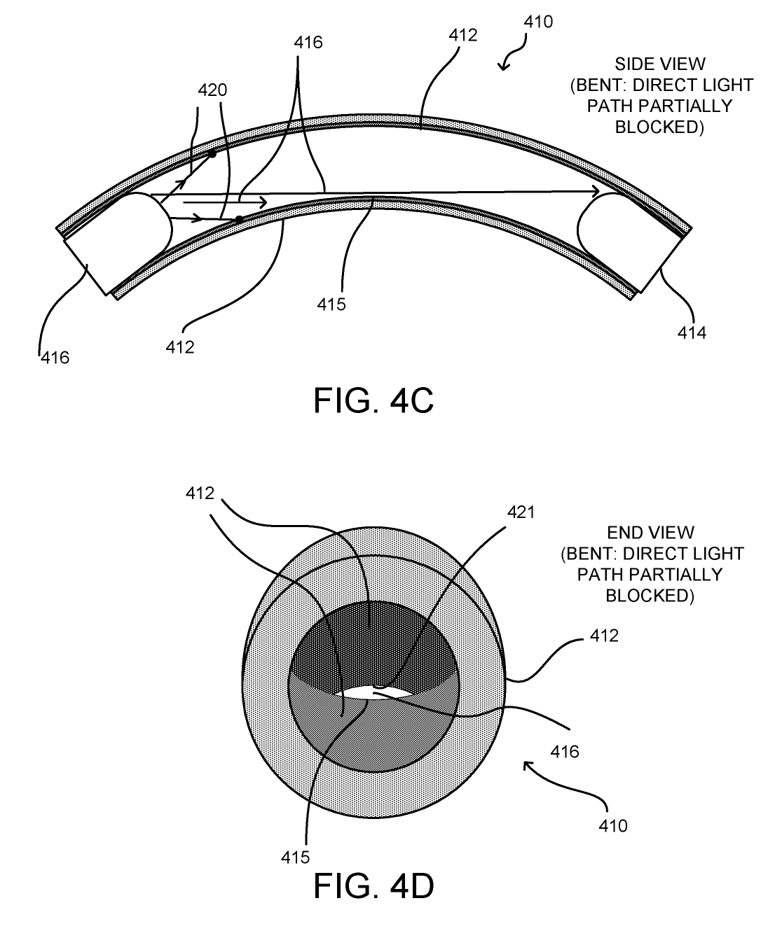

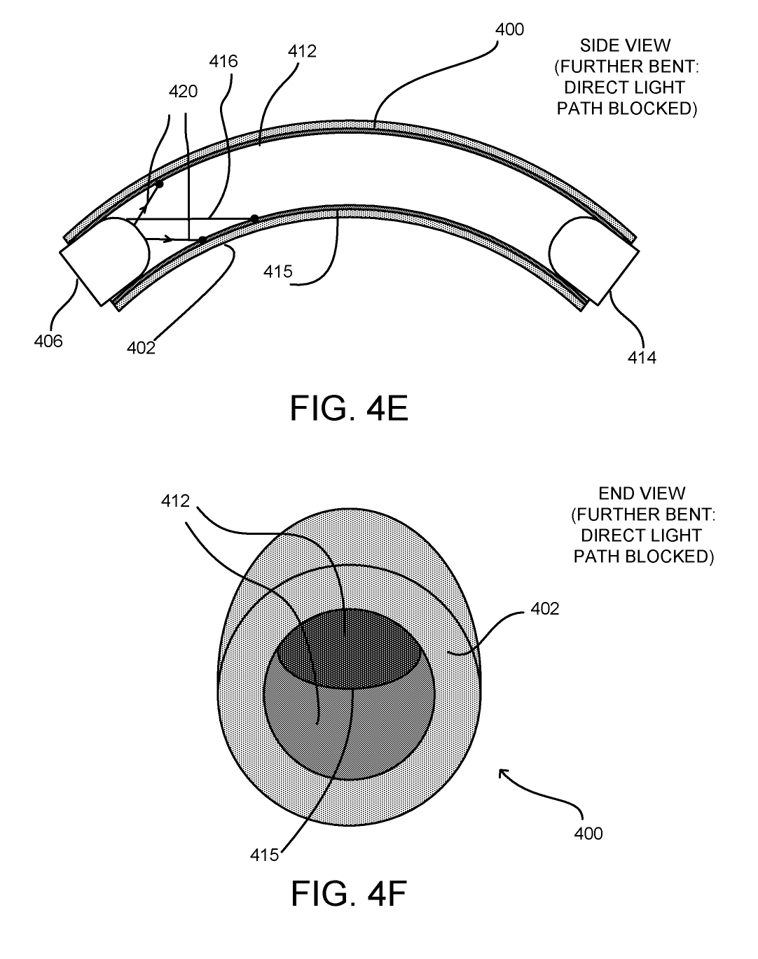

FIG. 4A is a schematic block diagram illustrating one embodiment of a direct light bend sensor 400 (fluid-filled) that has an inner surface 412 that is light absorbing. The direct light bend sensor 400 is depicted in a straightened disposition with a direct light path the aperture 421 (as shown in FIG. 4B below) unblocked such that direct light 416 from light source 406 is substantially unblocked as it passes through tube 402 to photodetector 414.

In one embodiment, the direct light bend sensor 400 includes a tube 402 that is elastically flexible, made of a darkening material, and has an inner surface 412 that is primarily light absorbing or substantially nonreflective. In the embodiment, direct light bend sensor 400 may include a light source 406 disposed in a first end portion of the tube 402 and a photodetector 414 disposed at a second end portion of the tube 402, such that the tube 402 includes a bend-dependent direct light path from the light source 406 to the photodetector 414 through an interior of the tube 402.

In some embodiments, the tube 402 has a straightened shape in response to the absence of one or more mechanical bending forces being applied to the tube 402. In other words, in the embodiments, when the tube 402 at least partially bent in response to a force being applied to at least a portion of the tube 402, the tube 402 returns back to a straightened shape in response to the absence of mechanical bending forces being applied to the tube 402.

In some embodiments, the tube 402 may be hollow and may be fluid-filled. As used herein, the word hollow as applied to a tube refers to the fact that the tube defines a channel that may be filled with something such as for example a gas or liquid. In some embodiments, the tube 402 may be filled with a transfer medium 404 that is an optically transmissive fluid such as for example an inert gas, air, water, and/or another fluid such as for example silicone oil.

In some embodiments, the transfer medium 404 may have a relatively low refractive index, such as for example, in the range of about 1.0003 to about 1.001. In other embodiments, the transfer medium 404 may have a moderately low refractive index in the range of about 1.35 to about 1.40. In some embodiments, a particular type of optically transmissive fluid which acts as the transfer medium 404 may have a predetermined refractive index appropriate for a particular type of light source 406 and a particular type of photodetector 414. In some embodiments, the optically transmissive fluid that comprises transfer medium 404 may further have characteristics that are adapted to a particular application. For example, in an application for measuring flow of a liquid, such as for example water, the transfer medium 404 may also be water so as to minimize possible effects caused by fluid going into or out of the tube 402.

In some embodiments, the tube 402 may be made of a darkening material (as may tubes 302, 502, 702, and/or 802), meaning not transparent and not primarily translucent to ambient light, so as to minimize the effect that ambient light may have on the amount of light detected by the photodetector 414 for a given degree of bending or unbending of the tube 402. In some embodiments, being made of a darkening material may refer to being made of a material or a combination of materials that is somewhat translucent but that is sufficiently darkening so as to reduce the amount of ambient light that may potentially interfere with or bias the measurement made of the degree of bending which is determined from the intensity of the direct light 416 emitted from the light source 406 that is detected by the photodetector 414. In some embodiments, the darkening material effectively increases the signal to noise ratio of the light intensity emitted from the light source 406 that is detected by the photodetector 414 during bending or straightening of the tube 402.

In some embodiments, a darkening material may be a dark or dark-colored material as defined herein. In other embodiments, a darkening material may be a light colored material such as white or amber which at least partially diminishes the intensity of a light exiting a surface of an object made from the material relative to the intensity of the light entering an opposite surface.

In some embodiments, some embodiments, as described above with respect to FIG. 3A-3C, the tube 402 may be substantially hollow and filled with air or with another optically transmissive fluid. In some embodiments, the inner surface 412 may be light absorbing, meaning that the intensity of light which the photodetector 414 may receive or not receive is predominately direct light 416 whether the tube 402 is in a straightened disposition or bent disposition. One example of an inner surface 412 that is light absorbing may be a black surface that is substantially light absorptive. The inner surface 412 may be a layer within the tube 402, or the tube 402 may be constructed of light absorptive material, for example, black latex rubber, or other dark-colored polymers or elastomers. As indicated, certain embodiments are directed to “dark-colored” materials. As used herein, “dark” or “dark-colored” refers to materials that are black as well as materials having a color approaching black in hue, including, for example, dark grey, dark blue, dark green, dark brown, and the like. As used herein, “black” includes all dark, optically black colors. The term “optically black” refers herein to a material which appears black and at least partially opaque on visual inspection. In certain embodiments, the dark-colored coating compositions of the present invention are optically black. In embodiments in which inner surface 412 is light absorbing, the light 420 is not generally reflected toward photodetector 414.

In some embodiments, the light source 406 may use one or more light emitting technologies. For example, in some embodiments, the light source 406 may include light emitting diodes, laser emitting diodes, incandescent bulbs, gas discharge light sources, electroluminescent light sources, radio luminescent light sources, gas discharge devices, and the like. In some embodiments, the light source 406 may be self-contained and/or self-powered, such as for example, a radioluminescent light source such as tritium (³H) that emits light. Moreover, in some embodiments, the light source 406 may be powered by an external power source such as a battery or another direct current power source or an alternating current power source, for example, to power a gas discharge light source such as a neon bulb.

In some embodiments, the photodetector 414 may be a photo resistor, a cadmium sulfide cell, a photodiode, a phototransistor, a solar cell, or any type of photosensitive detector. In the embodiment of FIG. 4A and in the other embodiments depicted in other figures, light source 406 (or similar light sources depicted in other figures) is disposed at one end of the tube 402 and the photodetector 414 is disposed at an opposite end of the tube 402. In other embodiments, the respective positions of the light source 406 and the photodetector 414 may be swapped.

Moreover, in some embodiments, both the light source 406 and the photodetector 414 may be disposed at the same end of the tube 402 and a reflective element, such as for example, a mirror (not shown) may be disposed at the opposite end of the tube 402. In such embodiments, the light 420 that is reflected from the mirror is regarded as a direct light 416 rather than being regarded as a light that is reflected because the path from the light source 406 to the photodetector 414 is a direct path (line of sight) such that bending of the tube 402 may affect the intensity of the direct light 416 significantly more than the fact that it is being reflected at a nearly orthogonal angle off of a reflective element such as a mirror.

FIG. 4B is a schematic block diagram illustrating an end view from the perspective of the photodetector 414 of the direct light bend sensor 400 (fluid-filled) of FIG. 4A in a straightened disposition with the direct light path unblocked. The direct light 416 from the light source 406 is transmitted through the tube 402. In some embodiments, the inner surface 412 may have an inner surface 412 that is light absorbing and does not reflect the light 420 toward the photodetector 414. In some embodiments, the inner diameter of the tube 402 may be the same at both ends. In FIG. 4B, the shading of the inner surface 412 illustrates that the direct light 416 shining through aperture 421 is direct light and thus, is not being reflected at an obtuse angle off of the inner surface 412.

FIG. 4C is a schematic block diagram illustrating a side view of the direct light bend sensor 400 (fluid-filled) of FIG. 4A in a bent disposition with a direct light path partially blocked. In the embodiment, the tube 402 is depicted in and at least partially bent disposition such that at least a portion of the direct light 416 is blocked by the apex 15 of the convex arc formed in the inner surface of tube 402 as it is bent. Another portion of the direct light 416 from the light source 406 is transmitted directly to photodetector 414 in this disposition because the bending of the tube 402 merely partially blocks the direct light 416 from the light source 406.

In some embodiments, the inner surface 412 is light absorbing e.g. black, absorptive, or otherwise light absorbing. Accordingly, the intensity of the direct light 416 decreases substantially as the tube is bent from a straightened position to a partially blocking or a substantially blocking bent position. Light other than the direct light 416 such as light 420 strikes the inner surface 412 which is light absorbing and thus light 420 generally does not reach photodetector 414.

The curvature of the tube 402 in a substantially bent position may be much less than depicted in FIGS. 4C-4F or as illustrated in any of the other embodiments depicted in FIGS. 5, 7B, 8, 9A-9C, 10, and/or 11. The longer the tube 402 is (for its given diameter), the less bending may be needed to effect a noticeable change in amount of direct light 416 that travels in a straight path through the aperture 421 to the photodetector 414.

FIG. 4D is a schematic block diagram illustrating an end view of the fluid-filled direct light bend sensor of FIG. 4A in a bent disposition with the direct light path partially blocked. In a substantially bent disposition, the direct light 416 is partially blocked by apex 415 as illustrated. Thus, even small changes in the degree of bending may result in significant changes in the intensity of the direct light transmitted from light source 406 to photodetector 414.

In some embodiments, the tube 402 may be comprised of material that is only slightly or merely moderately bendable. For example, the tube 402 (or similar tubes depicted in other Figures) may be made of nylon or polyvinyl chloride (PVC), which are significantly less bendable than latex rubber. Measurements can be made in embodiments in which tube 402 is merely slightly to moderately bendable because the length and the non-reflectivity of inner surface 412 facilitate a measurable change in light intensity. Even though as tube 402 uses stiffer, less bendable materials, the aperture 421 may not become very small compared with the inner diameter of tube 402. Thus, referring to tube 402 as substantially bent may refer to the fact that the tube 402 appears visibly bent to a human observer and it may also refer to the fact that the tube 402 is at least sufficiently bent such that a measurable difference in amount of the direct light 416 may be detected by the photodetector 414 in response to the tube being in a substantially bent position or alternatively in straightened position. The same maybe similarly noted of other embodiments of tubes depicted in the other Figures.

As previously described above, the resistive bend sensor 100 depicted in FIG. 1 may exhibit signal hysteresis as the sensor is straightened or time drift hysteresis. In other words, there may be a delay for a signal based on the resistance of the resistive bend sensor 100 to decrease as the resistive bend sensor 100 is being straightened or there may be a cumulative drift in signal over time. In some embodiments, the direct light bend sensor 400 exhibits negligible hysteresis. The direct light 416 travels at the speed of light from the light source 406 to the photodetector 414. Blocking of the direct light 416 by the apex 415 is immediately responsive to an increase in bending and/or straightening of the tube 402. Similarly, unblocking of the direct light 416 is immediately responsive to a decrease in bending of tube 402. Thus, direct light bend sensor 400, or those depicted or described in any of Figures may be especially suitable for applications where quick responsiveness is preferred.

FIG. 4E is a schematic block diagram illustrating a side view of the direct light bend sensor 400 (fluid-filled) of FIG. 4A in a further bent disposition with the direct light path blocked. In the embodiment illustrated, the direct light 416 from the light source 406 is substantially blocked by the apex 415 of the convex arc formed in the inner surface 412 of the tube 402 and thus is not direct light transmitted to the photodetector 414 because there is no line-of-sight aperture for a direct light path through the tube 402.

In some embodiments, the light 420 also fails to reach the photodetector 414 because it is not reflected off of inner surface 412 of the tube 402 which is primarily light absorbing rather than primarily light reflecting. Thus, the direct light 416 is substantially blocked by apex 415, and a significant difference in the intensity of light that may be detected by the photodetector 414 as the tube 402 bends from an angle within a partially blocked range of bending to any angle within a substantially blocked range of bending.

FIG. 4F is a schematic block diagram illustrating an end view of the fluid-filled direct light bend sensor of FIG. 4A in a further bent disposition with the direct light path blocked. In the embodiment, the direct light 416 is depicted as substantially blocked by the apex 415 of the inner surface 412 of the tube 402. Thus, there is no aperture shown in FIG. 4F for the direct light 416 to reach the photodetector 414.

FIG. 5 is a schematic block diagram illustrating one embodiment of system 500 that includes a direct light bend sensor 501 connected to a controller 526 and an output module 528. In some embodiments, the direct light bend sensor 501 includes a light source 506 disposed in a first end portion 508 of the tube 502 and a photodetector 514 disposed in a second end portion 510 that may be opposite the first end portion 508. In some embodiments, the tube 502 may be a fluid-filled tube that is flexible, made of a darkening material, and light absorbing as described with respect to tube 402, 702, and/or 802. In some embodiments, the light source 506 may be in electrical communication through a connection 536 with the controller 526. In some embodiments, the connection 536 may include power and signal connections. In some embodiments, the light source 506 may be self-powered, in which case, the connection 536 may be optional. The connection 536 may be unidirectional or bidirectional depending upon the type of the light source 506 and type of controller 526 used.

The connection 536 and another connection 534 may be routed externally to the tube 502 or internally through the tube 502 from either end. In some embodiments, the diameter of thin internally routed wires comprising the connections 534 and 536 may be small compared to an aperture or direct light path through tube 502 and the wires may be small gauge insulated wires for example. For sensitive applications, some embodiments may route the connections 534 and 536 outside of the inner surface 512 so as to avoid potential issues with blockage or interference caused by the connections 534 and/or 536 in the light path from the light source 506 to the photodetector 514.

In some embodiments, the system 500 includes a direct light bend sensor 501 that may function as a flexible photo potentiometer, that is a variable resistor having resistance that varies with the degree of bending. Accordingly, the controller 526 may use any means known to one of skill in the art for measuring variations in resistance. In some embodiments, the photodetector 514 may be a photoresistor (also known as a light dependent resistor). The resistance of a photoresistor decreases with increasing incident light. Conversely, the resistance of a photoresistor increases with decreasing incident light. Thus, the photodetector 514 may be used in a voltage divider circuit with a fixed resistor. The fixed resistor may be connected between a voltage source and an input of the controller and the photodetector 514 may be connected between the input of the controller and a ground.

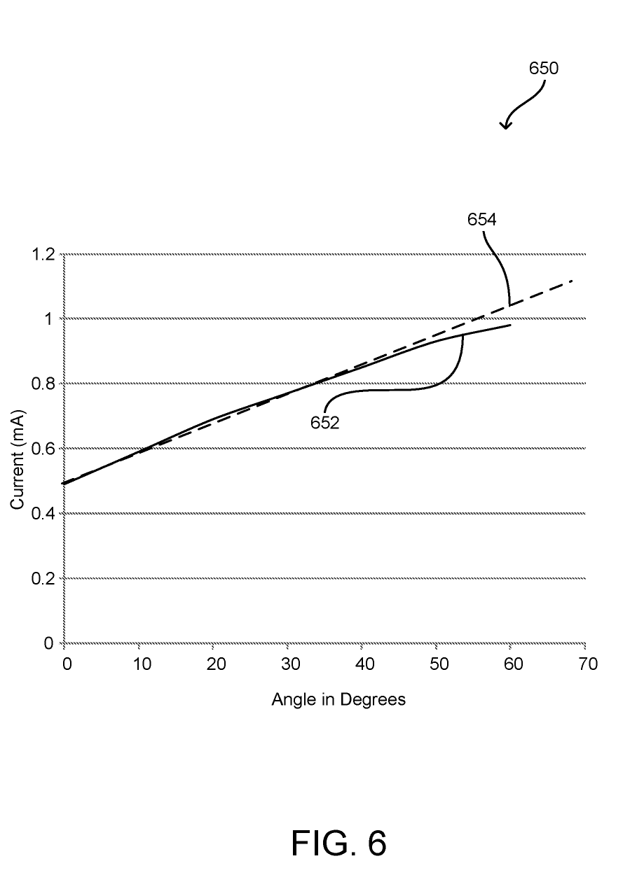

In some embodiments, current flowing to an input of the controller 526 increases as the tube 502 is bent, because the resistance of the photodetector 514 measured by the controller 526 increases as direct light 516 is increasingly blocked by the apex 515 as the tube 502 is bent, while the resistance of the fixed resistor stays the same. Thus, a current measured at an input of the controller 526 increases. An example of this is illustrated in FIG. 6 (described in more detail below) where the output curve 652 represents the current measured by the controller 526 which increases as the tube 502 is bent.

In some embodiments, for example, a simple counter timer circuit with a voltage input may be used to compare a voltage at an output of photodetector 514 with a reference voltage and may provide a pulse frequency that is directly proportional to an increase in resistance or conversely inversely proportional to an increase in resistance depending upon the configuration of the voltage controlled oscillator circuit.

Various other means known by a person of skill for measuring output from the photodetector 514 may be used for different types of photodetectors. An output module 528 may be in electrical communication with controller 526 via connection 538. In some embodiments, the connection 538 may be bidirectional or may be unidirectional and may carry digital or analog signals to and/or from the controller 526. In some embodiments, the controller 526 converts a measured value have signal from the photodetector to a predetermined unit of measurement and communicates the measured value in the predetermined unit of measurement to the output module 528. The output module 528 may then display a digital number representing the degree of bend, or may display an analog gauge showing the relative degree of bend pending or may include predetermined limits that enable a user to see whether the degree of bend falls within a specified range or ranges.

In some embodiments, the controller 526 and/or the output module 528 may convert signals measured from the photodetector 514 into predetermined units such as Newton meters or foot-pounds to represent a torque measurement. In other embodiments, the controller 526 and/or the output module 528 may convert signals measured from the photodetector 514 into predetermined units such as kilopascals, pounds per square inch, atmospheres, and the like, to represent a pressure measurement. In other embodiments, the controller 526 and/or the output module 528 may convert signals measured from the photodetector 514 into predetermined unit such as cubic feet per second, gallons per minute, or cubic meters per second, and the like for measuring volumetric flow rate of a fluid. The output module 528 may further include a connection 530 that may be connected to other components within a system, such as for example, a computer input.

FIG. 6 is a graph 650 of an output signal from a fluid-filled direct light bend sensor. An output curve 652 produced by a controller 526 or alternatively by an output module 528 (or similar elements depicted in the other Figures), in response to bending of a bend sensor e.g. 402, 502, 702, 802. In one embodiment, as depicted in FIG. 6, the output curve 6 represents the value in milliamps of current at various degrees of curvature of a tube, such as the tube 502 of the direct light bend sensor 501. A reference line 654 (dashed line) illustrates the substantial linearity of the output curve 652 over a wide range of bending of the tube 502. In some embodiments, the direct light bend sensor 501 operates in a linear portion of the output curve e.g., 652. In other embodiments, a non-linear portion of the output curve 652 can also be mapped to degrees of curvature of a direct light bend sensor, e.g., 502 or similar elements illustrated in the other figures.

As depicted in FIG. 6, the output curve 652 depicts an input current of about 0.5 mA in response to a curvature of about zero degrees in response to the direct light bend sensor 501 being in a straightened disposition. As the angle of bending of the tube 502 increases from 0 degrees to approximately 50 degrees and the aperture of the tube 702 decreases as direct light 516 is increasingly blocked by the apex 515 of the arc formed in the inner surface 512 of the tube 502, the output curve 652 increases substantially linearly.

As the degree of bending of the tube 502 passes from the partially blocked range to the substantially blocked range, e.g. beyond 60 degrees in this example, the output curve 652, if continued, would approach a substantially constant value as the direct light 516 from the light source is substantially blocked by the apex 515 (or similar apex as depicted in the other Figures) and continues to be substantially blocked by the apex 515 as the degree of bending of the tube 502 continues to increase.

FIG. 7A is a schematic block diagram illustrating one embodiment of a direct light bend sensor 700 (fluid-filled) with a flared portion 748. In addition to light source 706 and photodetector 714, some embodiments may include an indicator 754, that may be, for example, an LED that is on when direct light bend sensor 700 is powered or in operation. The indicator 754 may also be used to communicate a status, for example, a failure state.

A dimension 742 illustrates an inner dimension of tube 702. Another dimension 740 depicts an outer dimension of a body portion 746 of tube 702. In one embodiment, the direct light bend sensor 700 includes a flared portion 748 in which the dimensions of tube 702 may be suitably determined for a specific application. For example, in one embodiment where the direct light bend sensor 700 is used to sense torque between two surfaces, the length of the body portion 746 (dimension 752) is 0.620 inches. The length of flared portion 748, as illustrated by dimension 750, is 0.130 inches. Thus, the overall length of the direct light bend sensor 701 in a depicted embodiment is 0.750 inches. The inner dimension of tube 702 (dimension 742) in this embodiment is 0.085 inches and outer dimension of the body portion 746 of tube 702 is 0.156 inches. Dimension 742 illustrates the dimensions of aperture 721 of a bend-dependent direct light path for direct light 716 through tube 702 in a straightened disposition.

The outer dimension 744 of flared portion 748 of tube 702 in the embodiment depicted in FIG. 7A is 0.188 inches. The flared portion 748 may be conveniently used as a retaining feature. In some embodiments, the flared portion some 48 may simply result from choosing a photodetector 714 with a larger diameter than the diameter of light source 706. Other dimensions may be used in other embodiments according to the materials used and the bend radius of the tube 702.

The bend radius is typically defined as the minimum radius of curvature at which the tube may be bent while retaining its intended form, and below which the tube becomes deformed (e.g. kinked, or broken). The elasticity of the tube is the ability of the tube to be bent or flexed and to elastically stretch and to return to substantially its original shape in response to releasing a bending force that was applied to result in the bending. Stiffer polymers such as nylon and polyvinyl chloride can bend under a mechanical bending force and return to a straightened shaped when the mechanical bending force is no longer applied. Thus, for purposes of this application, they are elastic.

In some embodiments, an inner surface 712 of the tube 702 may be light absorbing. For example, the material used in one torque sensor embodiment was black latex rubber. Alternative materials may also be suitable including black nylon, black polyethylene, polypropylene, black polyvinyl chloride (PVC), and silicone. The elasticity of a tube such as tube 302, 402, 502, 702, and/or 802 causes it to return to a straightened shaped when no bending forces are applied, which provides for reuse of a direct light bend sensor many times with minimal calibration. It also minimizes drift or memory effect that would be seen if the tube 702 did not return to a straightened disposition after bending forces were applied and then released.

An advantage of the direct light bend sensor over other types of bend sensors is that it may be less expensive to manufacture and may be easily customized to meet the needs of particular application. Direct light bend sensors may be designed for general application or customized for a particular use by changing the materials and dimensions of the tubing. A ratio of the length from end to end of the tube to the diameter of the tube of greater than 4 to 1 to less than 10 to 1 may facilitate repeated use of the sensor with minimal deformation or bending, and may provide greater stability.

FIG. 7B is a schematic block diagram illustrating the direct light bend sensor 700 (fluid-filled) of FIG. 7A coupled to a first object 760 using a cable clamp 756 and configured to measure force applied by a second object 762. In some embodiments, the direct light bend sensor 701 may be mechanically coupled to first object 760, such as by the cable clamp 756 which may be coupled or affixed to the first object 760. The cable clamp 756 or any coupling device or fastener may be coupled to tube 702 at second end portion 710 or somewhere in the middle such that first end portion 708 or second end portion 710 of the tube may be bent as bending forces are applied to the tube. Light source 706 may be disposed at either end of tube 702 and photodetector 714 may be disposed at the opposite end.

Any chosen method of coupling of direct light bend sensor 700 to the first object 760 may be utilized, e.g. chemical, such as glue, or mechanical such as a clamp or fastener. In one embodiment, movement of a second object 762 a distance relative to the first object 760 may cause direct light bend sensor 700 to bend, as force from the movement of the second object 762 is applied to a first end portion 708 of the direct light bend sensor 700. As depicted, the first end portion 708 may be moved by movement of the second object 762. This movement and subsequent bending of direct light bend sensor 700 may occur in response to mechanical contact between the second object 762 and the first end portion 708 of the direct light bend sensor 700 causing the tube 702 to bend.

Even a small movement between the first object 760 and the second object 762 may cause direct light bend sensor 700 to become substantially bent. Thus, forces that might not easily be visible to a human observer may be measured by observing the response of direct light bend sensor 700 as it is caused to bend by the forces between the first object 760 and the second object 762. As with light guide bend sensor 300 and direct light bend sensors 400, 501, 701, and/or 801, the light path of direct light 716 is bend-dependent and the size of aperture decreases with increased bending until the direct light path is substantially blocked, in other words, the aperture of the bend-dependent direct light path for direct light 716 is substantially non-existent. In many embodiments, successful measurements can be made in a linear range without ever approaching a substantially blocked range of bending.

Light source 706 and photodetector 714 may be connected to a controller and an output module, such as output module 528 discussed with FIG. 5. Similarly, an output signal may be sent through a connection, such as connection 530 described with respect to FIG. 5, to indicate a degree of bending caused by the movement of first object 760 relative to second object 762. The output module may execute a calibration routine that calibrates the output signal to predetermined degrees of bending, for example, at a straightened disposition and at the point where the sensor is bent and well within a partially blocked range. The calibration routine may also convert the output into any selected unit of measurement. For example, in a torque sensor application, a unit of measurement may be foot-pounds or newton-meters.

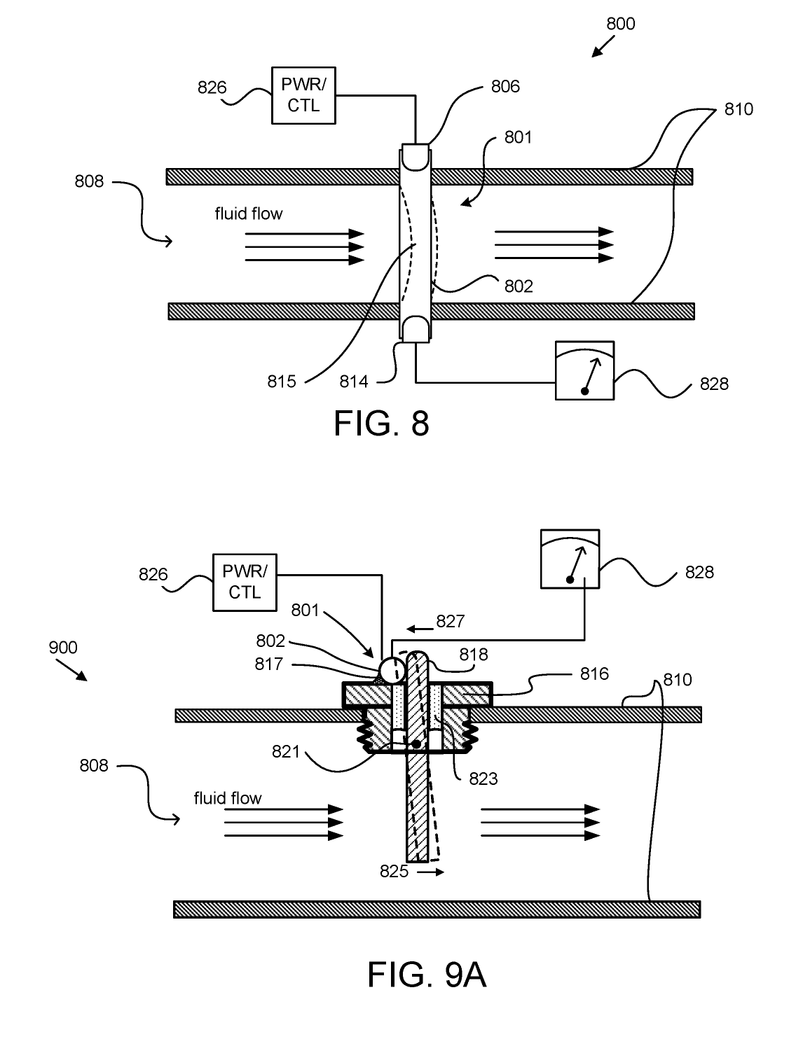

FIG. 8 is a schematic block diagram illustrating one embodiment of a system 800 that includes a direct light bend sensor 801 (fluid-filled) configured to directly measure flow. The direct light bend sensor 801 (fluid-filled) is coupled to a portion of a structure 810 that defines a channel for fluid flow 808. The system 800 further includes a controller 826 that connects to the direct light bend sensor 801 (fluid-filled). In some embodiments, the controller 812 provides power and/or control signals to/from the fluid-filled direct light bend sensor 811, for example at an end of the fluid-filled direct light bend sensor 811 that includes a light source 806. In some embodiments, the system 800 further includes an output module 828 that connects to the fluid-filled direct light bend sensor 811, for example at an end of the fluid-filled direct light bend sensor 811 that includes a photodetector 814.

In some embodiments, the output module 828 displays a value indicative of a measurement of fluid flow 808 in a structure 810 (channel) based on a signal from the photodetector 814. In response to the fluid flow 808 applying a force to at least a portion of the fluid-filled direct light bend sensor 811, the at least a portion of the fluid-filled direct light bend sensor 811 is bent so as to form an apex 815 that at least partially blocks direct light from the light source 806 to the photodetector 814.

It may be noted that the portion of the tube 802 of the fluid-filled direct light bend sensor 811 that is facing against the force being applied by the fluid flow 808 may, and some embodiments, bend to a greater degree than another portion of the tube 802 is facing away from the force being applied by the fluid flow 808. Thus, in some embodiments, the tube 802 of the direct light bend sensor 801 (fluid-filled) may be bent and straightened symmetrically or asymmetrically. In response to a lesser force being applied by the fluid flow 808 to the tube 802, the tube 802 becomes less bent and the amount of direct light transmitted from the light source 806 to the photodetector 814 increases. Thus, the system 800 may be configured to measure a first force that is directly applied to at least a portion of the tube of the direct light bend sensor in response to movement or flow of a fluid.

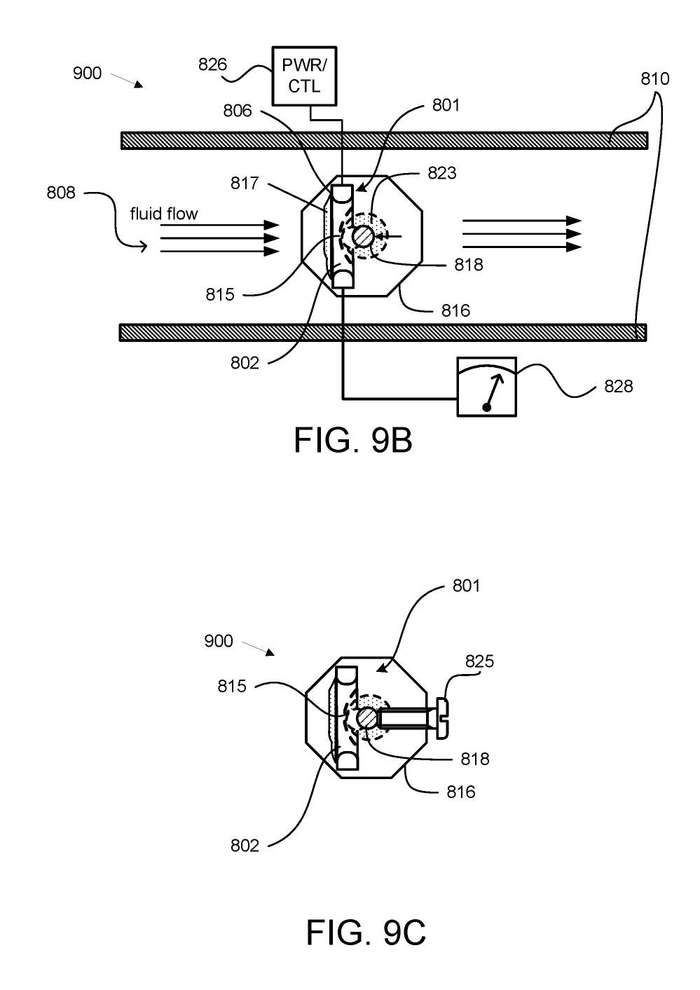

FIG. 9A is a schematic block diagram illustrating one embodiment of a system 900 that includes a direct light bend sensor 801 (fluid-filled) configured to measure fluid flow 808 within a channel defined by a structure 810 using an articulating arm 818. FIG. 9B is a schematic block diagram illustrating a top view of the system 900 of FIG. 9A. The system 900 includes a direct light bend sensor 801 (fluid-filled) that may be coupled to an adapter 816, for example using a fillet of glue 817.

In some embodiments, the system 900 may include a direct light bend sensor 801 (fluid-filled), a controller 826, and an output module 828 as described above with respect to FIG. 8, except that instead of the fluid flow 808 directly applying a first force to the tube 802 of the direct light bend sensor 801 (fluid-filled), the fluid flow 808 instead applies a first force to an articulating arm 818 that passes through the adapter 816.

In some embodiments, the adapter 816 may include a flexible sealant 823 that surrounds the articulating arm 818 and in response to a first force caused by the fluid flow 808 being applied to a first end of an object, e.g. the articulating arm 818, causes the articulating arm 818 to apply a second force 827 that causes at least a portion of the tube 802 to be bent, e.g., by a pivotal movement of the articulating arm 818. Similarly, in response to the fluid flow 808 applying a decreased force to the articulating arm 818, the second force 827 being applied to the at least a portion of the tube 802 is also decreased, causing at least a portion of the tube 802 to be straightened. In some embodiments, the adapter 816 may include a pin 821 that is coupled to the adapter 816 and about which the articulating arm 818 may pivot.

FIG. 9B is a schematic block diagram illustrating a top view of the system 900 of FIG. 9A. The system 900 operates as described above with respect to FIG. 9A which is a side view.

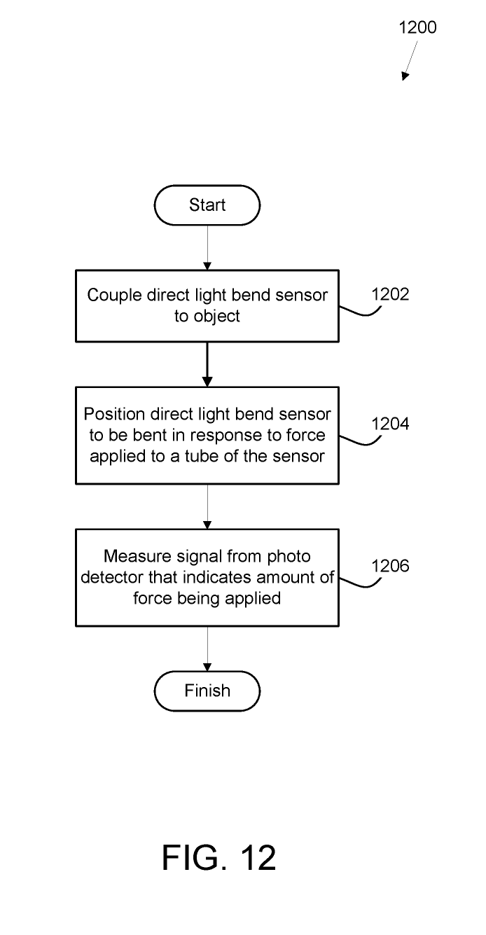

FIG. 9C is a schematic block diagram illustrating a top view of the fluid-filled direct light bend sensor of the system 900 of FIG. 9A configured with a calibration screw. The structure and operation of the system 900 may be substantially the same as described above with respect to FIG. 12B except that the embodiment of the system 900 illustrated in FIG. 9C further includes a calibration screw 825 that is adjustable. In some embodiments, the calibration screw 825 may be screwed in or out to apply a fixed amount of pressure to the articulating arm 818.

By applying a fixed amount of pressure to the articulating arm 818, a first reference value may be established at a first position of the second object e.g. the articulating arm 818 relative to the first object e.g. the adapter 816 based on the measurement of the signal from the photodetector 914 in response to the second object e.g. the articulating arm 818 being in the second position e.g. where the second position causes the tube 802 of the direct light bend sensor 801 (fluid-filled) to be bent or straightened.

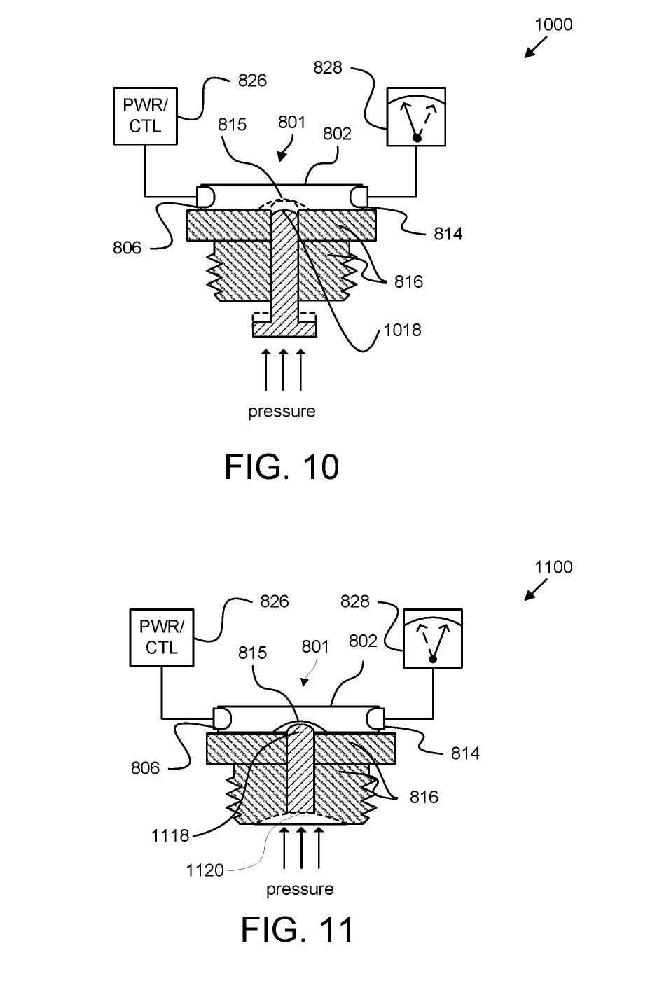

FIG. 10 is a schematic block diagram illustrating an embodiment of a system 1000 that includes direct light bend sensor 801 (fluid-filled) that is configured to measure pressure applied to a plunger. In some embodiments, the direct light bend sensor 801 (fluid-filled) is coupled to a first object such as adapter 816. In some embodiments, adapter a 16 may be a threaded adapter that includes a plunger 1018 that may move in response to pressure being applied to the plunger 1018. For example, as increased pressure is applied to an end of the plunger 1018 farthest from the direct light bend sensor 801 (fluid-filled), the plunger 1018 pushes against and bands a portion of the tube 802 so as to form an apex 815 that at least partially blocks direct light being emitted from a light source 806 towards a photodetector 814.

As with at least some of the other embodiments described above, the system 1000 may include a controller 826 that connects power and/or signals to the direct light bend sensor 801 (fluid-filled), for example, to/from the light source 806. In some embodiments, an output module 828 may be in connection with the direct light bend sensor 801 (fluid-filled), for example at the photodetector 814. In some embodiments, the controller 826 and/or the output module 828 may convert and/or display the amount of pressure being applied to the plunger 1018 based on at least a portion of the direct light bend sensor 801 (fluid-filled) being bent or straightened.

FIG. 11 is a schematic block diagram illustrating another embodiment of a system that includes fluid-filled direct light bend sensor configured to measure pressure applied to a membrane. In some embodiments, the system 1100 have a similar structure to and may operate substantially similarly to the system 1000 described above with respect to FIG. 10, except that in the embodiment of system 1100, the plunger 1118 may be coupled to a membrane 1120 that moves in response to a force being applied to it, e.g., I increase or decrease of pressure being applied to the membrane 1120.

FIG. 12 depicts a method 1200 of measuring force. The method 1200 includes coupling 1202 a direct light bend sensor to a first object, the direct light bend sensor including a tube that is elastically flexible, made of a darkening material, and has a light absorbing inner surface. The direct light bend sensor further includes a light source disposed in a first end portion of the tube and a photodetector disposed in a second end portion of the tube, wherein an inner portion of the tube defines a bend-dependent direct light path from the light source to the photodetector. It may be noted by one of ordinary skill that within the method 1200, the direct light bend sensor may be any direct light bend sensor script above e.g., 400, 500, 700, 800, 900, 1000, or 1100.

The method 1200 continues and includes positioning 1204 the direct light bend sensor to be at least partially bent in response to a first force being applied to at least a portion of the tube. For example, in the embodiments described with respect to FIG. 7B, in response to a first force being applied to the tube 702 by the movement of the second object 762, depicted in the illustration as a downward movement, a first end portion 708 of the tube 702 is positioned to be at least partially bent (e.g., as shown by the dashed lines).

In other embodiments, such as for example as depicted in FIG. 8, a first force created by fluid flow 808 may be applied to a center portion of the tube 802. It may be noted in the illustration of FIG. 8 that a side of the tube 802 facing against the fluid flow 808 may in some embodiments be bent to a greater degree than an opposite side of the tube 802.

The method 1200 continues and includes measuring 1206 a signal from the photodetector that indicates a magnitude of the first force. For example, as illustrated in FIGS. 8, 9A-9B, 10, or 11, an output module 828 may be used to measure a signal from the photodetector 814 that indicates a magnitude of the first force, e.g., the first force being applied directly or indirectly to at least a portion of the tube 802. In some embodiments, the output module 828 may be part of a controller 826 while in other embodiments, the output module 828 may be separate from controller 826. In some embodiments, the output module 828 may indicate a calibrated value in predetermined units for the magnitude of the first force. And the method 1200 ends.

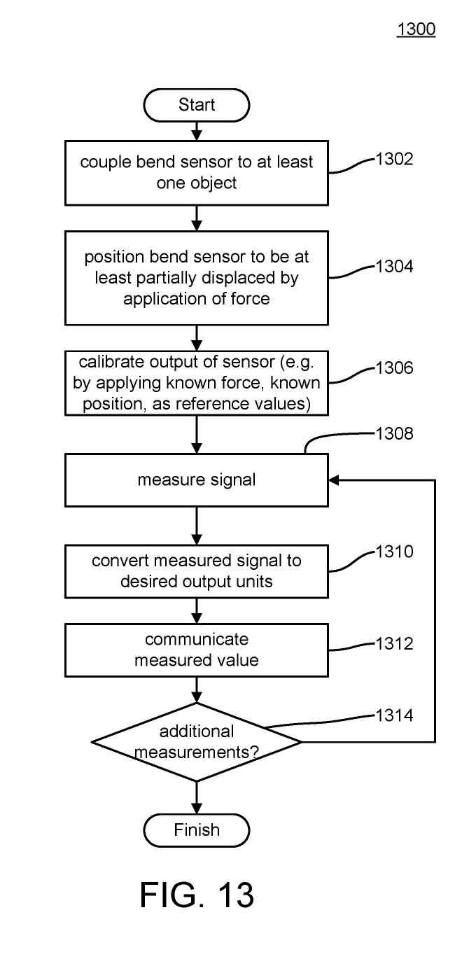

FIG. 13 is a schematic flow chart diagram illustrating another embodiment of a method 1300 for measuring a force using a fluid-filled direct light bend sensor. In some embodiments, the method 1300 starts and includes coupling 1302 a direct light bend sensor to a first object. The coupling 1302 to an object may be accomplished by any of the means described above. For example, FIG. 7B illustrates an embodiment in which coupling the tube 702 of the bend sensor to the first object 760 is accomplished using a cable clamp 756. In other embodiments such as depicted in FIG. 9A-9C, 10, or 11, the tube 802 of the direct light bend sensor 801 is coupled to the adapter 816 e.g. using glue 817. In other embodiments, that direct light bend sensor e.g. 801 may be mechanically coupled to an object, such as for example, by cable clamp 756 shown in FIG. 7B.

In the embodiments of the method 1300, the direct light bend sensor includes a tube that is elastically flexible, made of a darkening material, and has a light absorbing inner surface. The direct light bend sensor further includes a light source disposed in a first end portion of the tube and a photodetector disposed in a second end portion of the tube, wherein an inner portion of the tube defines a bend-dependent direct light path from the light source to the photodetector. The structure of the direct light bend sensor may be substantially as described above with respect to any of FIGS. 3A- 11B.

The method 1300 continues and includes positioning 1304 the direct light bend sensor to be at least partially bent in response to a first force being applied to at least a portion of the tube. In some embodiments, the act of positioning 1304 the direct light bend sensor to be at least partially displaced by an application of force may be done substantially as described above with respect to FIGS. 7B, 8, 9A-9C, 10, or 11. The method 1300 further includes measuring 1308 a signal from the photodetector that indicates a magnitude of the first force.

In some embodiments, the method 1300 enables the direct light bend sensor as described herein may be used in a wide variety of applications. For example, in some embodiments such as illustrated in FIGS. 8, 9A-9C, the direct light bend sensor may be used in a flow sensor. In such embodiments, the first force may be directly applied to at least a portion of the tube of the direct light bend sensor in response to movement/flow of a fluid.

In other embodiments, the first force that causes the tube to bend is applied to at least a portion of the tube of the direct light bend sensor in response to a second force being applied to the second object that is movable relative to the first object. For example, the flow sensor application illustrated in FIG. 8 illustrates a direct application of a first force whereas the flow sensor application of FIGS. 9A-9C illustrate methods and systems in which the first force (the pushing of an articulated arm, a plunger, or a membrane, or combinations thereof) is applied to at least a portion of the tube of the direct light bend sensor in response to a second force being applied to a second object that is movable relative to the first object (e.g., first object 760 in FIG. 7B, or articulating arm 818 in FIGS. 9A-9C.

In some embodiments, such as illustrated in FIGS. 10 and 11, the method 1300 enables the direct light bend sensor to be used as a pressure gauge, such as for example, by using a plunger and or a membrane that applies a force against a tube of the direct light bend sensor causing it to be at least partially bent.

In some embodiments, the method 1300 further includes converting a measured value of the signal to a predetermined unit of measurement and communicating the measured value in the predetermined unit of measurement. For example, in the embodiment illustrated in FIG. 8B, the application of the direct light bend sensor may be a torque measuring application which the predetermined unit of measurements are Newton meters or other standard units of torque as described above with respect to FIG. 7B.

In some embodiments, the method 1300 further includes calibrating 1306 an output of the direct light bend sensor prior to measuring 1308 the signal. For example, in some embodiments, the act of calibrating 1306 may include establishing a first reference value at a first position of the second object relative to the first object based on the measuring of the signal from the photodetector in response to the second object being in the first position.

The act of calibrating 1306 further includes establishing a second reference value at a second position of the second object relative to the first object based on the measuring of the signal from the photodetector in response to the second object being in the second position and calibrating an output of the direct light bend sensor based upon the first and second reference values. One of skill in the art may apply any known method of calibration to enhance the ability of the direct light bend sensor to provide accurate measurements.

In some embodiments, such as illustrated in FIG. 9C, the act of calibrating 1306 may include adjusting a calibration mechanism such as for example a calibration screw 825. By adjusting the calibration screw 825 in or out, a repeatability precise reference point of minimal bending may be established. In other words, a zeroing value or another minimum value may be set for the direct light bend sensor.

By way of another example, in FIG. 7B, positioning a first end portion 708 of the tube 702 so that movement of a distance ‘d’ of second surface 762 as shown causes the first end portion 708 to be displaced by corresponding distance, which in turn causes the tube 702 to bend. The bending of the direct light bend sensor 701 decreases the intensity of direct light 716 as the direct light bend sensor 701 goes from the substantially unblocked range to the partially blocked range. The intensity of light may continue to decrease until the bending of the provided directly light bend sensor causes it to go from the partially blocked range to the blocked range at which point the direct light from the light source in the provided direct light bend sensor is blocked.

In some embodiments, a second reference may be established at any curvature or degree of bending of the tube, and typically would fall within the partially blocked range of direct light. Establishing a second reference point at a degree of bending well within the substantially blocked range may result in a higher degree of uncertainty regarding the degree of bending since in the substantially blocked range the output of light varies little due to the fact that the intensity of light varies little within the substantially blocked range.

When calibration values and algorithms have been established through the act of calibrating 1306 an output of the direct light bend sensor based on the first and second reference values, a measurement of the degree of bending of the direct light bend sensor caused by the relative motion or forces between the first and second objects may be converted to predetermined output units such as by the output module 528 illustrated in FIG. 5 or other Figures.

In some embodiments, the method 1300 of using the direct light bend sensor may be such that the output varies substantially linearly as the direct light bend sensor bands in response to the second object moving from the first position to the second position as described above with respect to FIG. 7B. Moreover, in some embodiments, the method 1300 of using the direct light bend sensor may be such that the direct light bend sensor response to unbending with negligible hysteresis, whereas the resistive bend sensors described above with respect to FIG. 1 may exhibit measurable hysteresis. As used herein hysteresis refers to a tendency on the part of bend sensor such as the resistive bend sensor to exhibit over time a tendency or the signal generated by bending and unbending not to return to the same value for a given degree of bending or unbending, or to do so in a less responsive manner or in a manner that exhibits drift.

As further illustrated in FIG. 13, the method 1300 may be used iteratively to make multiple measurements through the acts of measuring 1308 a signal, converting 1310 measured signal to desired output units, as described above, communicating 1312 the measured value, and determining 1316 whether any additional measurements are to be made. The method 1300 further includes determining 1314 whether additional measurements are to be made, and if so the method 1300 returns to the act of measuring 1308 the signal and continues, or if no additional measurements are to be made the method 1300 finishes.

Referring again to FIGS. 5, 7A-7B, 8, 9A-9C, 10, 11, in some embodiments, a system (e.g., 500, 700, 900, 1000, 1100) is disclosed that includes a direct light bend sensor (e.g., direct light bend sensor 801) that is coupled to a first object (e.g., adapter 816). In the embodiments, the direct light bend sensor includes a fluid-filled tube (e.g., tube 802) that is elastically flexible, made of a darkening material, and has a light absorbing inner surface. The direct light bend sensor further includes a light source (e.g., light source 806) disposed in a first end portion of the fluid-filled tube. In the embodiments, the system further includes a photodetector disposed in a second end portion of the fluid-filled tube and a bend-dependent direct light path from the light source to the photodetector through the fluid-filled tube.

In some embodiments, the system further includes a controller (e.g. 526, 826) that measures changes in a signal from the photodetector in response to a bending of a least a portion of the fluid-filled tube, the bending in response to a force being applied to a second object (e.g., articulating arm 818, plunger 1018, 1118, membrane 1120, etc.).

In some embodiments, the system (e.g., 500, 700, 900, 1000, 1100) further includes an output module (e.g. 528, 828) that displays in predetermined units a magnitude of the force being applied to the second object.

The present invention may be embodied in other specific forms without departing from its spirit or essential characteristics. The described embodiments are to be considered in all respects merely as illustrative and not restrictive. Although very narrow claims are presented herein, it should be recognized the scope of this invention is much broader than presented by the claims. It is intended that broader claims will be submitted in an application that claims the benefit of priority from this application. Insofar as the description above and the accompanying drawings disclose any additional subject matter that is not within the scope of the claims below, the inventions are not dedicated to the public and the right to file one or more applications to claim such additional inventions is reserved.

What is claimed is:

1. A direct light bend sensor comprising:
an elastically flexible tube made of a darkening material and having a light absorbing inner surface;
a light source disposed in a first end portion of the tube; and
a photodetector disposed in a second end portion of the tube, wherein an inner surface of the tube defines a bend-dependent direct light path from the light source to the photodetector.

2. The direct light bend sensor of claim 1 wherein the tube is filled with an optically transmissive fluid.

3. The direct light bend sensor of claim 1 wherein the optically transmissive fluid is chosen from the group consisting of an inert gas, air, water, and silicone oil.

4. The direct light bend sensor of claim 1 wherein the tube has a straightened shape in response to an absence of mechanical bending forces being applied to the tube.

5. The direct light bend sensor of claim 1 wherein a cross-sectional area of the bend-dependent direct light path decreases in size in response to at least a portion of the tube being bent and increases in size in response to the at least a portion the tube being straightened.

6. The direct light bend sensor of claim 1 wherein the light absorbing inner surface comprises a dark colored elastomer.

7. The direct light bend sensor of claim 1 wherein the light source comprises at least one light emitting element chosen from the group consisting of light emitting diodes, laser diodes, radioluminescent light sources, incandescent bulbs, and gas discharge light sources.

8. The direct light bend sensor of claim 7 wherein the at least one light emitting element emits visible light.

9. The direct light bend sensor of claim 7 wherein the at least one light emitting element emits infrared light.

10. The direct light bend sensor of claim 1 wherein the photodetector comprises at least one light-sensing element selected from the group consisting of photoresistors, photodiodes, phototransistors, cadmium sulfide cells.

11. A method for measuring force comprising:
coupling a direct light bend sensor to a first object, the direct light bend sensor comprising:
an elastically flexible tube made of a darkening material and having a light absorbing inner surface;
a light source disposed in a first end portion of the tube; and
a photodetector disposed in a second end portion of the tube, wherein an inner surface of the tube defines a bend-dependent direct light path from the light source to the photodetector;
positioning the direct light bend sensor to be at least partially bent in response to a first force being applied to at least a portion of the tube; and
measuring a signal from the photodetector that indicates a magnitude of the first force.

12. The method of claim 11 wherein the first force is directly applied to the at least a portion of the tube in response to movement of a fluid.

13. The method of claim 11, wherein the first force is applied to the at least a portion of the tube in response to a second force being applied to a second object that is movable relative to the first object.

14. The method of claim 13 wherein second object is selected from the group consisting of an articulating arm, a plunger, a membrane, and combinations thereof.

15. The method of claim 13, further comprising converting a measured value of the signal to a predetermined unit of measurement and communicating the measured value in the predetermined unit of measurement.

16. The method of claim 13, further comprising:
establishing a first reference value at a first position of the second object relative to the first object based on the measuring of the signal from the photodetector in response to the second object being in the first position;
establishing a second reference value at a second position of the second object relative to the first object based on the measuring of the signal from the photodetector in response to the second object being in the second position; and
calibrating an output of the direct light bend sensor based upon the first and second reference values.

17. The method of claim 16, wherein the output varies substantially linearly as the direct light bend sensor bends in response to the second object moving from the first position to the second position.

18. The method of claim 17, wherein the direct light bend sensor responds to unbending with negligible hysteresis.

19. A system comprising:
a direct light bend sensor coupled to a first object, the direct light bend sensor comprising:
an elastically flexible fluid-filled tube made of a darkening material and having a light absorbing inner surface;
a light source disposed in a first end portion of the fluid-filled tube; and
a photodetector disposed in a second end portion of the fluid-filled tube,
wherein an inner surface of the fluid-filled tube defines a bend-dependent direct light path from the light source to the photodetector through the fluid-filled tube; and
a controller that measures changes in a signal from the photodetector in response to a bending of at least a portion of the fluid-filled tube, the bending in response to a force being applied to a second object.

20. The system of claim 19, further comprising
an output module that displays in predetermined units a magnitude of the force being applied to the second object.
